(19) United States
(12) Patent Application Publication
(10) Pub. No.: US 2020/0137987 A1
(43) Pub. Date: May 7, 2020

(54) AIRTIGHT POULTRY HOUSE AND INTELLIGENT MONITORING AUTOMATIC CONTROL SYSTEM THEREOF AND POULTRY HOUSE COLLECTING LARGE DATA RELATED TO GROWTH FACTOR CORRELATION AND COMFORMING TO BIOLOGICAL CONTROL SAFETY

(71) Applicant: Yuan Jin Chuang Enterprise Co.,Ltd, New Taipei City (TW)

(72) Inventors: Hung-Yuan Wu, Yunlin County (TW); Meng-Hui Lin, Yunlin County (TW)

(73) Assignee: Yuan Jin Chuang Enterprise Co.,Ltd, New Taipei City (TW)

(21) Appl. No.: 16/296,263

(22) Filed: Mar. 8, 2019

(30) Foreign Application Priority Data
Nov. 6, 2018 (TW) 107139265

(51) Int. Cl. A01K 31/22; A01K 45/00

(52) U.S. Cl. CPC A01K 31/22; A01K 45/00

(57) ABSTRACT

The invention relates to an airtight poultry house and an intelligent monitoring automatic control system thereof that collects large data related to growth factor correlation. The intelligent monitoring automatic control system includes: at least one detection module disposed in a processing unit for generating a farming area data according to the airtight state of at least one poultry farming area; at least one control module disposed in the processing unit, wherein each of the at least one control module is provided with a processing unit automatic control rule, and each of the at least one control module is used to automatically control the desired airtight state for the farming environment according to the processing unit automatic control rule and the farming area data and to put the at least one poultry farming area in a negative pressure state; and a database storing the farming area data.

### CROSS-REFERENCE TO RELATED APPLICATION

This application claims the priority benefit of Taiwan application serial no. 107139265, filed on Nov. 6, 2018. The entirety of the above-mentioned patent application is hereby incorporated by reference herein and made a part of this specification.

### BACKGROUND OF THE INVENTION

### Technical Field

The invention relates to a poultry house, and more particularly, to an airtight poultry house that adopts an intelligent monitoring automatic control system and collects large data related to growth factor correlation and conforming to biological control safety.

### Description of Related Art

The Agricultural 4.0 data referred to today is the integration of information on the relevant data of farming, processing, and sales, establishing a database, and is extended to each product, and even manufacturing data for raw materials, so that each user may use the product with peace of mind and consume it without worry. In particular, with the development of animal husbandry, the concept of saving labor costs has gradually been valued by the industry. In order to improve quality, the poultry farming industry must integrate the control of the farming environment, such as: controlling a plurality of items such as temperature, humidity, illumination, air quality, drinking water, feed quantity, and weight collection, and the data of each batch of poultry such as breeding, hatching, farming, slaughtering, processing, and sales is consolidated and collected in order to achieve the objective of establishing a production resume.

At present, poultry farming is mostly operated in the form of on-site supervision and treatment for long periods of time. Farming environmental items of on-site treatment and supervision include controlling temperature, humidity, illumination, air quality, drinking water, feed quantity, body weight, feed efficiency etc., and for owners of mass farming, a large amount of manpower is required. Moreover, artificial control of farming environment equipment is also prone to human error.

Therefore, it is necessary to propose a system that may improve the efficiency and quality of poultry farming and may reduce the reliance on the manpower of on-site workers and may effectively deal with and solve problems immediately when problems occur, and a monitoring automatic control systems is further needed to collect information on farming history to study big data to find out the correlation between growth factors and the environment to automatically generate the best production modes in different production domains.

### SUMMARY OF THE INVENTION

In view of the shortcomings of the prior art, the main objective of the invention is to provide an intelligent monitoring automatic control system of an airtight poultry house capable of improving the efficiency and quality of poultry farming that may reduce the dependence on the manpower of on-site workers and may perform immediate and effective treatment and solve problems when problems occur. Moreover, the system is also capable of recording farming environmental data, and via the analysis and treatment of poultry farming on-site farming environment information by the system, poultry farmers or relevant management personnel of the farming area may obtain instant and accurate information to make correct and efficient judgment and improve the quality of poultry farming. After future analysis, the computer may be trained to automatically calculate the optimal growth mode of each plant.

The invention provides an intelligent monitoring automatic control system of an airtight poultry house, including: at least one detection module disposed in a processing unit for generating a farming area data according to the airtight state of at least one poultry farming area; at least one control module disposed in the processing unit, wherein each of the at least one control module is provided with a processing unit automatic control rule, and each of the at least one control module is used to automatically control the airtight state of the at least one poultry farming area via the processing unit according to the automatic control rule and the farming area data, so that the at least one poultry farming area is in a negative pressure state; and a database configured to store the farming area data via the processing unit, and the processing unit automatically generates a plurality of analytical data according to the farming area data and the airtight state of the at least one poultry farming area; wherein each of the plurality of analytical data is to be read by at least one of a video wall, a desktop computer, a notebook computer, a car computer, a personal digital assistant, a tablet computer, a smart phone, a digital photo frame, a wearable device, and an alarm via the processing unit.

When the intelligent monitoring automatic control system of the airtight poultry house of the invention is started, the at least one detection module generates the farming area data according to the airtight state of the at least one poultry farming area, and then each of the at least one processing unit is used to automatically control the airtight state of the at least one poultry farming area according to the automatic control rule and the farming area data, so that the at least one poultry farming area is in a negative pressure state, thereby achieving the effect of eliminating bird flu, and the at least one intelligent control module may reduce the reliance on the manpower of on-site workers to achieve the objective of immediate and effective treatment and problem solving when a problem occurs. Moreover, the system may also analyze and process the poultry farming on-site information via the database, for example: a feed conversion rate, where the system automatically records a feed quantity of the poultry, and an average weight of the poultry. The processing unit takes data information from the database, and automatically converts the feed conversion rate via a formula: Feed conversion rate=Total feed quantity/Total weight gain, and records the result to the database; wherein each of the plurality of analytical data is to be provided and exported by at least one of a video wall, a desktop computer, a notebook computer, a car computer, a personal digital assistant, a tablet computer, a smart phone, a digital photo frame, and a wearable device to be read. Farming information is obtained for analysis and judgment to improve the quality of poultry farming.

Further, each of the at least one detection module includes: at least one of an air pressure sensor, a temperature sensor, a humidity sensor, and a gas component sensor, and at least one of the air pressure sensor, the temperature sensor, the humidity sensor, and the gas component sensor and a combination thereof are used to generate the farming area data to be recorded to the database; wherein each of the plurality of analytical data is to be exported by at least one of a video wall, a desktop computer, a notebook computer, a car computer, a personal digital assistant, a tablet computer, a smart phone, a digital photo frame, and a wearable device to be read; and each of the plurality of the analytical data is used for an airtight poultry house in combination with market product demand analysis and evaluation of airtight poultry house capacity utilization rate.

Further, each of the control modules includes: at least one of a wind speed module, a water curtain module, and a spray module, wherein the wind speed module refers to an air volume and a wind speed for controlling the fan, and at least one of the wind speed module, the water curtain module, and the spray module and a combination thereof are used to automatically control the temperature of the airtight state of the at least one poultry farming area according to the processing unit automatic control rule and the farming area data when the automatic control rule is triggered by the farming area data.

Further, each of the at least one detection module includes: at least one of an illumination sensor, a water quantity sensor, and a feed quantity sensor, and at least one of the illumination sensor, the water quantity sensor, the feed quantity sensor, and a combination thereof generate the farming area data via the processing unit and store the data in the database, wherein each of the plurality of analytical data is to be provided and exported by at least one of a video wall, a desktop computer, a notebook computer, a car computer, a personal digital assistant, a tablet computer, a smart phone, a digital photo frame, and a wearable device to be read.

Further, each of the control modules includes: at least one of an at least one lighting fixture, at least one automatic water diverter, and at least one automatic feeder and a combination thereof, and each of the at least one lighting fixture, each of the at least one automatic water diverter, and each of the at least one automatic feeder are respectively used to automatically control the feed quantity and lighting time of the airtight state of the at least one poultry farming area according to the automatic control rule in the processing unit and the farming area data in the database when the automatic control rule is triggered by the farming area data.

Further, each of the at least one poultry farming area includes at least one weighing platform, each of the weighing platforms is used to generate a scale data, the processing unit automatically calculates food consumption and growth rate of the poultry in at least one poultry farming area according to the farming area data generated by the scale information and the combination of the water quantity sensor and the feed quantity sensor, and integrates them to be automatically stored in the database via the processing unit, wherein each of the plurality of analytical data is to be exported by at least one of a video wall, a desktop computer, a notebook computer, a car computer, a personal digital assistant, a tablet computer, a smart phone, a digital photo frame, and a wearable device to be read.

Further, each of the control modules further includes: a poultry dosing module automatically controlling the airtight state of the at least one poultry farming area according to the automatic control rule and the farming area data when the detection module detects the automatic control rule is triggered by the farming area data.

Further, each message sending module sends a preset message to the telecommunication equipment of a designated recipient by at least one trigger message sending module of the automatic control rule in the processing unit when the processing unit automatic control rule is being exceeded by the value of farming area data or lower than a preset alarm limit value.

Further, the intelligent monitoring automatic control system of the airtight poultry house further includes: an uninterrupted power system connected to at least one of the at least one detection module, the at least one control module, and the database to ensure the power safety of at least one of the at least one detection module, the at least one control module, and the database.

Further, the intelligent monitoring automatic control system includes a human-machine interface to allow at least one user to register, log in, and manage the plurality of analytical data on the intelligent monitoring automatic control system via at least one of a video wall, a desktop computer, a notebook computer, a car computer, a personal digital assistant, a tablet computer, a smart phone, and a wearable device; and is also configured to perform inspection on the at least one detection module and manually controlling or setting the value of the at least one control module for automatic control.

Further, the human-machine interface of the intelligent monitoring automatic control system is used to output the plurality of analytical data via one of a webpage, an application, an embedded component, a wearable device, a smart phone, and a tablet computer.

In view of the above disadvantages of the prior art, the main objective of the invention is to provide an airtight poultry house including: an airtight house body including at least one poultry farming area; and an intelligent monitoring automatic control system of the airtight poultry house disposed in the poultry house body to control the airtight state of the at least one poultry farming area in the poultry house body.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a structural view of an airtight poultry house and an intelligent monitoring automatic control system thereof of the invention.

FIG. 2 is a schematic of the detailed structure of an intelligent monitoring automatic control system of an airtight poultry house of the invention.

FIG. 3 is a schematic of the operation flow of an automatic water diverter of an intelligent monitoring automatic control system of an airtight poultry house of the invention.

FIG. 4A is a schematic of the operation flow of an automatic feeder of an intelligent monitoring automatic control system of an airtight poultry house of the invention.

FIG. 4B is a schematic of the architecture of an automatic feeder of an intelligent monitoring automatic control system of an airtight poultry house of the invention.

FIG. 5 is a schematic of the interaction between an intelligent monitoring automatic control system of an airtight poultry house of the invention and a user.

FIG. 6 is a schematic of the poultry house body of FIG. 1.

### DESCRIPTION OF THE EMBODIMENTS

In the following, specific embodiments are used to describe the implementation of the invention. Those skilled in the art may better understand the other advantages and efficacy of the invention from the contents disclosed in the present specification. The invention may also be implemented or applied through other different specific embodiments, and the details of the present specification of the invention may also be modified and changed based on different views and applications without departing from the spirit of the invention.

It is to be understood that the structure, the proportion, the size, the number of components, and the like in the drawings of the present specification are only used to match the contents disclosed in the specification for understanding and reading by those skilled in the art, and are not intended to limit the applicable limiting conditions of the invention. Therefore, the above are not technically meaningful, and any modification of the structure, change of the proportional relationship, or adjustment of the size shall fall within the scope applicable to the technical contents disclosed in the invention without affecting the resulting effects and the achievable objectives of the invention.

Hereinafter, an airtight poultry house and an intelligent monitoring automatic control system thereof are described according to an embodiment of the invention. The system is also capable of recording poultry growth status data such as: growth cycle average weight, livability rate, feed conversion rate, evenness, and the like. Details are as follows:

1. Feed conversion rate (FCR), also known as feed change rate. Formula: FCR=Total feed volume/Total weight gain=Feeding cycle cumulative feeding kilogram/Survival count*Daily average weight (e.g. 6000 kg/3125*0.975 kg=1.87).

2. Livability rate. Formula: Livability rate=Survival count/Initial number of poultry*100% (example: 3125/3435*100%=91%).

3. Evenness: Percentage of number of poultry within +−10% of average weight. Formula: Evenness=Number of poultry within average weight/Total number.

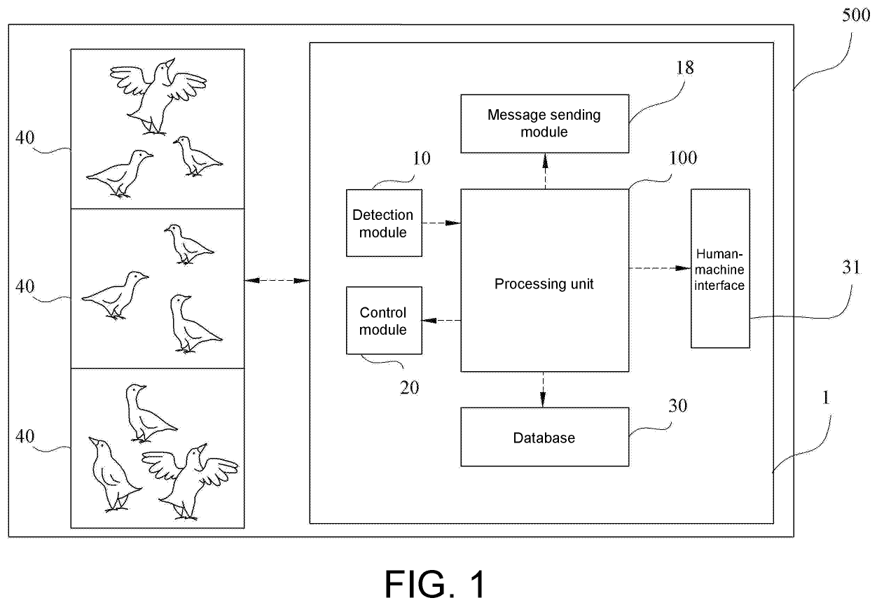

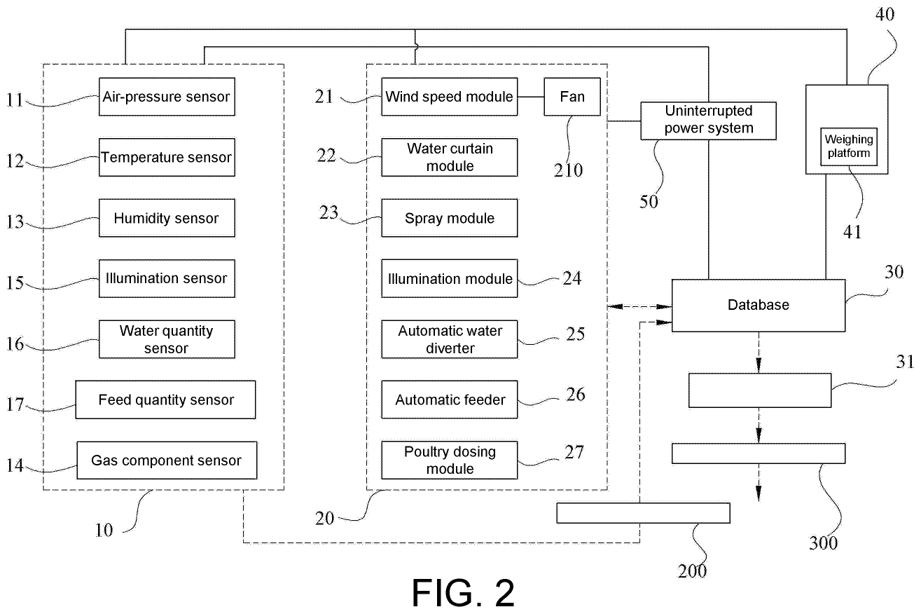

Referring to FIG. 1 and FIG. 2, an intelligent monitoring automatic control system 1 of the airtight poultry house of the invention includes: a detection module 10, a control module 20, and a database 30. The detection module 10 is disposed in the intelligent monitoring automatic control system 1 for generating a farming area data 200 according to an airtight state of at least one poultry farming area 40 (3 are exemplified in the present embodiment). In the present embodiment, the intelligent monitoring automatic control system 1 is one of a wired or wireless Internet, a World Wide Web (WWW), an Internet of Things (IoT), and a blockchain; the detection module 10 includes an air pressure sensor 11, a temperature sensor 12, a humidity sensor 13, and a gas component sensor 14, and the air pressure sensor 11, the temperature sensor 12, the humidity sensor 13, and the gas component sensor 14 are used to generate a farming area data 200; wherein the gas component sensor 14 is used to detect at least one of oxygen, carbon dioxide, and ammonia. In an embodiment of the invention, the detection module 10 includes an illumination sensor 15, a water quantity sensor 16, and a feed quantity sensor 17, and the illumination sensor 15, the water quantity sensor 16, and the feed quantity sensor 17 are used to generate the farming area data 200. Although each of the sensors in the detection module 10 of the present embodiment is exemplified by one, the configuration and number of the sensors may be decided according to requirements.

The processing unit 100 is provided with a processing unit automatic control rule (not shown). The processing unit 100 is used to automatically control the airtight state of the poultry farming area 40 according to the processing unit automatic control rule (not shown) and the farming area data 200, so that the poultry farming area 40 is in a negative pressure state. In the present embodiment, the control module 20 includes: a wind speed module 21, a water curtain module 22, and a spray module 23. The wind speed module 21, the water curtain module 22, and the spray module 23 are used to automatically control the airtight state of the poultry farming area 40 via the processing unit 100 according to the processing unit automatic control rule (not shown) and the farming area data 200 when the processing unit automatic control rule (not shown) is triggered by the farming area data 200 (for example, the farming area data 200 shows that at least one of air pressure, temperature, humidity, gas composition, illumination, water quantity, and feed quantity is abnormal). In the present embodiment, the wind speed module 21 is used to control a fan 210. The processing unit 100 regulates the action of at least one fan or the simultaneous action of a plurality of fans of the control module 20 to control air volume.

In addition, the control module 20 further includes: a lighting fixture 24, an automatic water diverter 25, and an automatic feeder 26. The lighting fixture 24, the automatic water diverter 25, and the automatic feeder 26 are respectively used to automatically control the airtight state of the poultry farming area 40 according to the processing unit automatic control rule (not shown) and the farming area data 200 when the processing unit automatic control rule (not shown) is triggered by the farming area data 200 (for example, the farming area data 200 shows that at least one of air pressure, temperature, humidity, gas composition, illumination, water quantity, feed quantity, and body weight is abnormal). In the present embodiment, the control module 20 may further include: a poultry dosing module 27 for automatically controlling the airtight state of the poultry farming area 40 according to the processing unit automatic control rule (not shown) and the farming area data 200 when the processing unit automatic control rule (not shown) is triggered by the farming area data 200. In the present embodiment, the poultry dosing module 27 may guide the medicine to be delivered to the poultry farming area 40 via a water channel such as the water curtain module 22 and the spray module 23 via the automatic water diverter 25.

The database 30 is used to store the farming area data 200 via the processing unit 100 and automatically generate a plurality of analytical data 300 according to the farming area data 200 and the airtight state of the poultry farming area 40; wherein each of the plurality of analytical data 300 is to be read via the processing unit 100 by at least one of a video wall, a desktop computer, a notebook computer, a car computer, a personal digital assistant, a tablet computer, a smart phone, a digital photo frame, a wearable device, and an alarm. In the present embodiment, the database 30 includes a human-machine interface 31 for at least one user to register, log in, and manage the plurality of analytical data 300 via at least one of a video wall, a desktop computer, a notebook computer, a car computer, a personal digital assistant, a tablet computer, a smart phone, and a wearable device on the processing unit 100 and to control at least one of the detection module 10 and the control module 20. In the present embodiment, the human-machine interface 31 is used to output a plurality of analytical data 300 via one of a webpage, an application, an embedded component, a wearable device, and an alarm. Moreover, each of the analytical data 300 is used for an airtight poultry house poultry farming area 40 in combination with market product demand analysis and evaluation of the capacity utilization of the airtight poultry house poultry farming area 40.

In the present embodiment, the poultry farming area 40 includes a weighing platform 41 for generating a scale data (not shown), and the database 30 automatically calculates the food consumption and growth rate of the poultry in the poultry farming area 40 and integrates them into the plurality of analytical data 300 according to the scale information and the farming area data 200 generated by the combination of the water quantity sensor 16 and the feed quantity sensor 17. In the present embodiment, the weighing platform 41 generates a scale data by measuring poultry of at least one of a particular species, quantity, sex, and combinations thereof in the poultry farming area 40.

In the present embodiment, the intelligent monitoring automatic control system 1 of the airtight poultry house of the invention further includes: an uninterrupted power system 50 connected to the detection module 10, the control module 20, and the database 30. In another embodiment not shown, the uninterrupted power system 50 may be connected to one or a plurality of the detection module 10, the control module 20, and the database 30 according to requirements, and is not limited herein.

In the present embodiment, the intelligent monitoring automatic control system 1 of the airtight poultry house is disposed in the poultry house body 500 to control the airtight state of the poultry farming area 40 in the poultry house body 500.

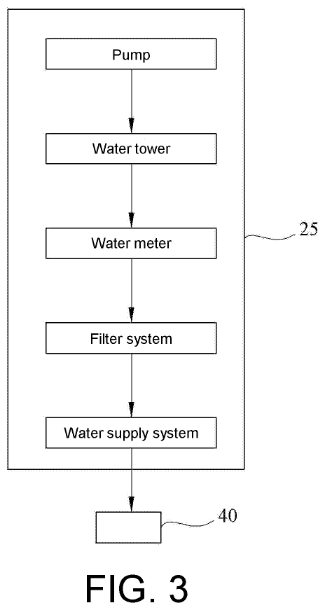

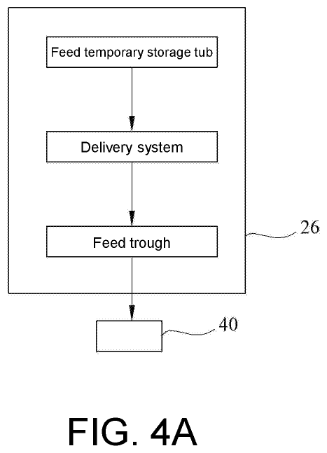

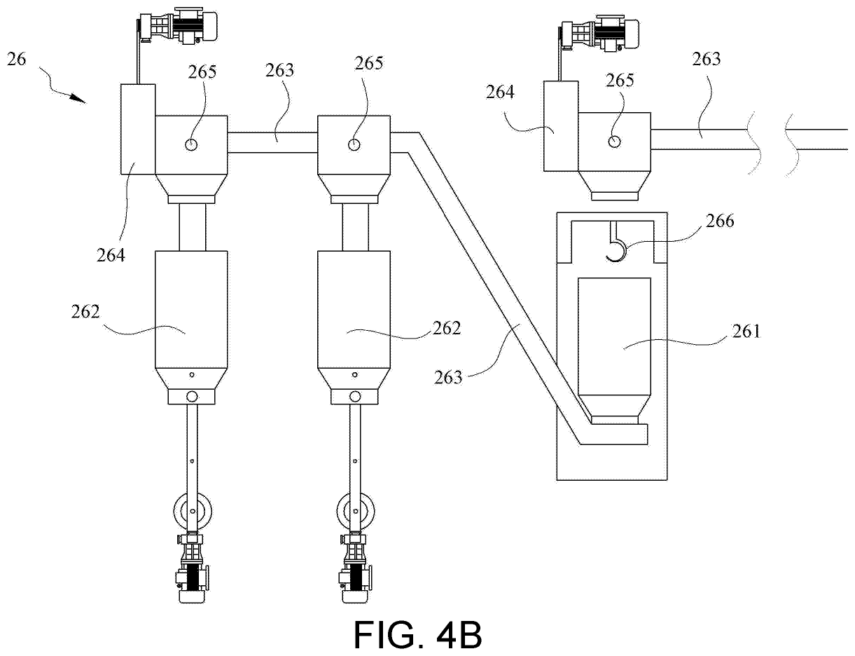

FIG. 3 is a schematic of the operation flow of the automatic water diverter 25 of the intelligent monitoring automatic control system 1 of the airtight poultry house of the invention; and FIG. 4A is a schematic of the operation flow of an automatic feeder of an intelligent monitoring automatic control system of an airtight poultry house of the invention; FIG. 4B is a schematic of the structure of an automatic feeder of an intelligent monitoring automatic control system of an airtight poultry house of the invention.

According to FIG. 4B, a feeding procedure of the automatic feeder 26 of the invention is as follows: at the beginning, a self-feed tube 263 fills the feed into a main tub 261 via a scale 266 via the control of a weight sensor 265 and a feed motor 264 above the main tub 261. Next, the feed stored in the main tub 261 is transferred to a plurality of sub-tubs 262 via another section of the feed tube 263, and an appropriate feed delivery weight is controlled via the weight sensor 265 and the feed motor 264 above the plurality of sub-tubs 262, and then the weighted feed portion is transferred to poultry farming via the plurality of sub-tubs 262. In particular, the weight sensors 265 respectively corresponding to the main tub 261 and the sub-tubs 262 may be the same as or different from the aforementioned feed quantity sensor 17 to prevent the feed motor 264 from being stopped when the feed is excessive, thereby achieving a good feed efficiency.

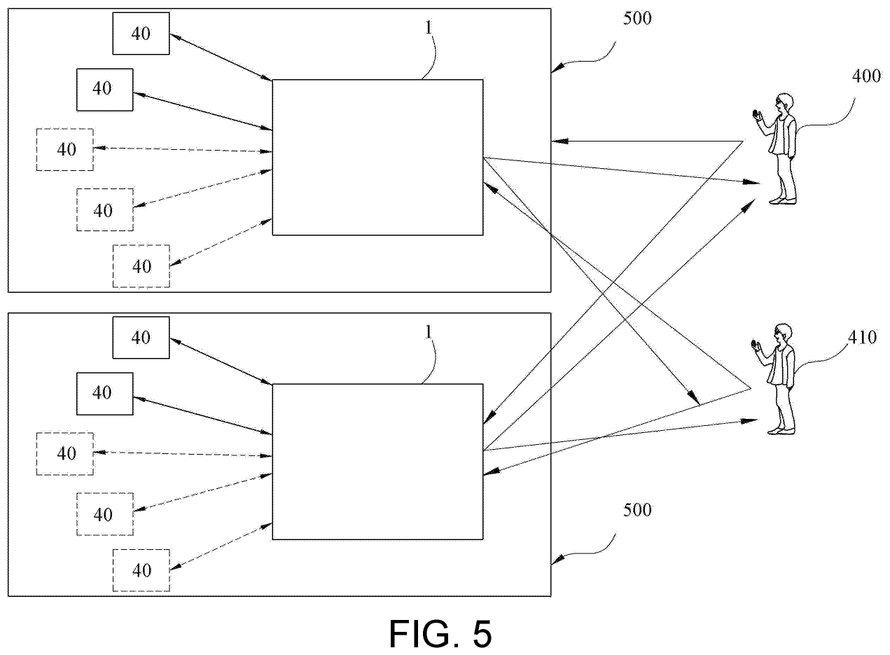

FIG. 5 is a schematic of the interaction between an intelligent monitoring automatic control system of an airtight poultry house of the invention and a user. In the present embodiment, a user 400 and another user 410 may freely configure the control and monitoring authority of the poultry farming area 40 in the poultry house body 500 according to requirement (achieved by the intelligent monitoring automatic control system 1 and the human-machine interface 31 as shown in FIG. 2). For example, the user 400 controls two poultry farming areas 40 and the user 410 controls four poultry farming areas 40 to achieve the objective of free customization, thus adding flexibility in control and improving the operational efficiency of the poultry house body 500.

As described above, the technical content of the invention discloses collecting the farming history information and large data analysis via the monitoring automatic control system, finding out the correlation between the growth factor and the environment, automatically generating the best production mode of different production areas, and applying them in agricultural animal husbandry to improve market assessment and performance evaluation. For example, temperature control is significantly related to the rate of mortality reduction. Therefore, if the analytical data of each module conflicts with each other, then the temperature is taken as the first priority consideration factor, and after the correlation of each value is fed, the upper and lower limits (automatic control of numbers) of the original input produce different calculation results.

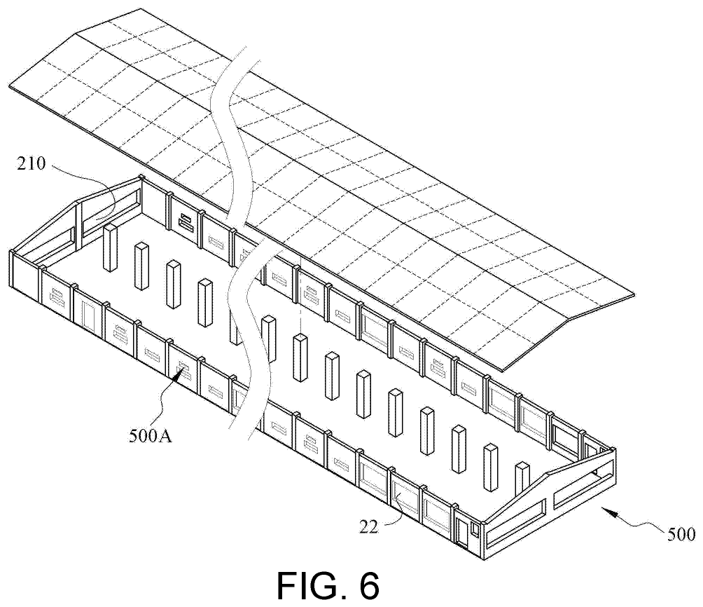

FIG. 6 is a schematic of the poultry house body of FIG. 1. Referring to FIG. 6, the poultry house body 500 is, for example, elongated, and a span of the poultry house body 500 may depend on a form of a roof thereof, a type of the poultry house (open or closed), and a manner of feeding. In general, the open span is 6 to 10 meters, and the closed span is 12 to 15 meters. The length of the poultry house body 500 generally depends on the span thereof and a degree of mechanization of management. The poultry house body 500 with a span of 6 to 10 meters generally has a length of 30 to 60 meters; and the poultry house body 500 with a larger span, such as 12 meters generally has a length of 70 to 80 meters. A height of the poultry house body 500 with a higher degree of mechanization may be greater, but generally should not exceed 100 meters, otherwise the production and installation of mechanical equipment is more difficult, and materials are not easy to be dealt with. In addition, the height of the poultry house body 500 may be determined according to a feeding method, a method of cleaning the manure, the span, and the weather conditions.

The poultry house body 500 may be tunnel ventilated, and the fan 210 may be disposed at one end of the length direction thereof, and the number thereof may be, for example, 4 to 6 groups controlled in sections. In addition, the poultry house body 500 may be provided with side windows 500A that may be opened in sections, and 4 to 6 pieces of the water curtain module 22 disposed at two sides of the span direction thereof to introduce fresh air from the outside. The water curtain modules 22 may be located at the other end of the poultry house body 500 away from the fans 210.

Therefore, when the air passes through the water curtain modules 22, the air is cooled due to the absorption of heat by evaporation of moisture, and the temperature of the poultry house body 500 may be lowered. In addition, via the forced exhaust of the fans 210, the heat generated by the poultry may be removed. When the poultry sucks in the cool air, the effect of removing the heat in the lungs may also be achieved. Moreover, the convective heat dissipation of poultry reaches maximum removal speed, and because of air cooling, the convection heat dissipation of poultry is increased. In addition, another function of the water curtain modules 22 is to remove undesirable gases and indirectly reduce respiratory diseases, eye problems, and other diseases of poultry caused by bad gas. For example, reducing the number of bacteria, increasing the amount of oxygen in the air, etc., may all reduce disease.

In contrast, heat preservation is especially important in the growth stage of the poultry chicks. Smaller poultry are more sensitive to cold stimulation. Therefore, moderate temperature reduction of the poultry house is important. Therefore, the control of the water curtain modules 22 is even more important. In addition, in another embodiment, a baffle may be provided inside the poultry house body 500 for flow conversion, and a fence is used to partition the poultry to prevent the poultry from excessively gathering in a cooler place.

In order to achieve the foregoing and other objects, an intelligent monitoring automatic control system of an airtight poultry house of the invention includes: at least one detection module 10 for generating a farming area data in an airtight environment of a poultry farming area; and at least one control module 20 disposed in the processing unit 100. The control module 20 is provided with a processing unit automatic control rule, and the processing unit 100 is used to automatically control the airtight state of the poultry farming area according to the processing unit automatic control rule and the farming area data, such as setting the temperature to 15 degrees, and when the on-site temperature is equal to 15 degrees, the system automatically turns on the first fan (small). When the temperature is equal to 16 degrees, the system automatically turns on the second fan (medium). When the on-site temperature reaches 17 degrees, the system automatically turns on the third fan (large). When the on-site temperature is equal to or greater than 17 degrees for over 5 minutes, the system further adds a water curtain to assist in cooling, so that the temperature of the at least one poultry farming area drops to a set value. The above example is only a simple description for the operation mode of the processing unit 100 and is not a necessary limitation of the invention. The processing unit 100 also performs automatic control behavior on the humidity, illumination, pressure, etc. of the detection module 10 of the system; and a database 30 stores the farming area data via the processing unit 100 and automatically generates a plurality of analytical data according to the farming area data and the airtight state of the at least one poultry farming area; wherein each of the plurality of analytical data is to be exported via at least one of a video wall, a desktop computer, a notebook computer, a car computer, a personal digital assistant, a tablet computer, a smart phone, a digital photo frame, and a wearable device to be read.

When the intelligent monitoring automatic control system of the airtight poultry house of the invention is started, the detection module 10 generates the farming area data 200 according to the airtight state of the poultry farming area 40, and then the control module 20 is configured to automatically control the airtight state of the poultry farming area 40 according to the processing unit automatic control rule and the farming area data 200 such that the poultry farming area 40 is in a negative pressure state. As a result, the efficacy of eliminating bird flu may be achieved, and the reliance on the manpower of the on-site staff may be reduced via the intelligent control module 20, so as to achieve the objective of immediate and effective treatment and problem solving when a problem occurs. Moreover, the system may also analyze and process the poultry farming on-site information via the database 30, so that the poultry farmers or the relevant management personnel of the farming area may obtain instant information via at least one of a video wall, a desktop computer, a notebook computer, a car computer, a personal digital assistant, a tablet computer, a smart phone, a digital photo frame, a wearable device, and an alarm to make a correct and efficient judgment and enhance the quality of poultry farming, and after future analysis, a computer may be trained to automatically calculate the optimal growth mode of each plant.

In addition, in the present embodiment, the intelligent monitoring automatic control system of the airtight poultry house is connected to a National Epidemic Center or connected to an external weather meter. When relevant epidemic situation information of the National Epidemic Center is received, the frequency of external spraying of disinfectant may be increased. When the information of the weather meter is determined to reach a certain state (for example, colder weather resulting in an increase of bird flu factor), the number of indoor disinfection spraying is automatically increased. Furthermore, since although the poultry house body 500 of the present embodiment is a closed poultry house, there is still a diversion system of the fans 210 and the side windows 500A to assist in cooling and increasing oxygen content, so the possibility of airborne infection still exits. In particular, at least 40% of known diseases are transmitted via the air, and another 40% of diseases are transmitted via fluid contact. Nearly 10% of diseases are highly correlated with fecal contamination, and 70% of sudden acute diseases are related to ambient air quality. Therefore, the airtight poultry house of the present embodiment may also assist in flow disinfecting liquid via external reflection and a low screen density design to naturally form a protective wall and hinder the opportunity of airborne infection and in combination with fecal safety to prevent the occurrence of at least half of the diseases.

What is claimed is:

1. An intelligent monitoring automatic control system of an airtight poultry house, comprising:
at least one detection module, disposed in a processing unit, configured for generating a farming area data according to an airtight state of at least one poultry farming area;
at least one control module, disposed in the processing unit, wherein each of the at least one control module is provided with a processing unit automatic control rule, and each of the at least one control module is configured to automatically control the airtight state of the at least one poultry farming area via the processing unit according to the processing unit automatic control rule and the farming area data, so that the at least one poultry farming area is in a negative pressure state; and
a database configured to store the farming area data via the processing unit, and the processing unit automatically generates a plurality of analytical data according to the farming area data and the airtight state of the at least one poultry farming area; wherein each of the plurality of analytical data is to be read by at least one of a video wall, a desktop computer, a notebook computer, a car computer, a personal digital assistant, a tablet computer, a smart phone, a digital photo frame, a wearable device, and an alarm via the processing unit.

2. The intelligent monitoring automatic control system of the airtight poultry house according to claim 1, wherein each of the at least one detection module comprises: at least one of an air pressure sensor, a temperature sensor, a humidity sensor, and a gas component sensor, and at least one of the air pressure sensor, the temperature sensor, the humidity sensor, and the gas component sensor and a combination thereof are used to generate the farming area data; and each of the plurality of the analytical data is used for an airtight poultry house in combination with market product demand analysis and evaluation of a capacity utilization of the airtight poultry house poultry farming area.

3. The intelligent monitoring automatic control system of the airtight poultry house according to claim 2, wherein when the analytical data of the air pressure sensor, the temperature sensor, the humidity sensor, or the gas component sensor conflict with each other, the analytical data of the temperature sensor takes priority as a consideration factor.

4. The intelligent monitoring automatic control system of the airtight poultry house according to claim 2, wherein each of the control modules comprises: at least one of a wind speed module, a water curtain module, and a spray module, and at least one of the wind speed module, the water curtain module, and the spray module and a combination thereof is configured to automatically control the airtight state of the at least one poultry farming area according to the processing unit automatic control rule and the farming area data when the processing unit automatic control rule is triggered by the farming area data.

5. The intelligent monitoring automatic control system of the airtight poultry house according to claim 1, wherein each of the at least one detection module comprises: at least one of an illumination sensor, a water quantity sensor, and a feed quantity sensor, and at least one of the illumination sensor, the water quantity sensor, and the feed quantity sensor and a combination thereof are used to generate the farming area data.

6. The intelligent monitoring automatic control system of the airtight poultry house according to claim 4, wherein each of the control modules comprises: at least one of an at least one lighting fixture, at least one automatic water diverter, and at least one automatic feeder and a combination thereof, and each of the at least one lighting fixture, each of the at least one automatic water diverter, and each of the at least one automatic feeder are respectively used to automatically control the airtight state of the at least one poultry farming area according to the processing unit automatic control rule and the farming area data when the processing unit automatic control rule is triggered by the farming area data.

7. The intelligent monitoring automatic control system of the airtight poultry house according to claim 4, wherein each of the at least one poultry farming area comprises at least a weighing platform, each of the weighing platforms is used to generate a scale data, the processing unit automatically calculates a food consumption and a growth rate of the poultry in at least one of the poultry farming areas according to a scale information and the farming area data generated by a combination of the water quantity sensor and the feed quantity sensor, and an analytical data is generated via a formula calculation and integrated into the plurality of analytical data.

8. The intelligent monitoring automatic control system of the airtight poultry house according to claim 3, wherein each of the control modules further comprises: a poultry dosing module, configured to automatically control the airtight state of the at least one poultry farming area according to the processing unit automatic control rule and the farming area data processing unit when the processing unit automatic control rule is triggered by the farming area data.

9. The intelligent monitoring automatic control system of the airtight poultry house according to claim 1, wherein a correlation analysis is performed on each of the plurality of analytical data according to a growth factor of the poultry.

10. The intelligent monitoring automatic control system of the airtight poultry house according to claim 1, further comprising: an uninterrupted power system connected to at least one of the at least one detection mode, the at least one control module, and the database.

11. The intelligent monitoring automatic control system of the airtight poultry house according to claim 1, wherein the database comprises a human-machine interface to allow at least one user to register, log in, and manage the plurality of analytical data via at least one of a video wall, a desktop computer, a notebook computer, a car computer, a personal digital assistant, a tablet computer, a smart phone, and a wearable device and to control at least one of the at least one detection module and the at least one control module.

12. The intelligent monitoring automatic control system of the airtight poultry house according to claim 2, wherein the database comprises a human-machine interface to allow at least one user to register, log in, and manage the plurality of analytical data via at least one of a video wall, a desktop computer, a notebook computer, a car computer, a personal digital assistant, a tablet computer, a smart phone, and a wearable device and to control at least one of the at least one detection module and the at least one control module.

13. The intelligent monitoring automatic control system of the airtight poultry house according to claim 3, wherein the database comprises a human-machine interface to allow at least one user to register, log in, and manage the plurality of analytical data via at least one of a video wall, a desktop computer, a notebook computer, a car computer, a personal digital assistant, a tablet computer, a smart phone, and a wearable device and to control at least one of the at least one detection module and the at least one control module.

14. The intelligent monitoring automatic control system of the airtight poultry house according to claim 4, wherein the database comprises a human-machine interface to allow at least one user to register, log in, and manage the plurality of analytical data via at least one of a video wall, a desktop computer, a notebook computer, a car computer, a personal digital assistant, a tablet computer, a smart phone, and a wearable device and to control at least one of the at least one detection module and the at least one control module.

15. The intelligent monitoring automatic control system of the airtight poultry house according to claim 5, wherein the database comprises a human-machine interface to allow at least one user to register, log in, and manage the plurality of analytical data via at least one of a video wall, a desktop computer, a notebook computer, a car computer, a personal digital assistant, a tablet computer, a smart phone, and a wearable device and to control at least one of the at least one detection module and the at least one control module.

16. The intelligent monitoring automatic control system of the airtight poultry house according to claim 6, wherein the database comprises a human-machine interface to allow at least one user to register, log in, and manage the plurality of analytical data via at least one of a video wall, a desktop computer, a notebook computer, a car computer, a personal digital assistant, a tablet computer, a smart phone, and a wearable device and to control at least one of the at least one detection module and the at least one control module.

17. The intelligent monitoring automatic control system of the airtight poultry house according to claim 7, wherein the database comprises a human-machine interface to allow at least one user to register, log in, and manage the plurality of analytical data via at least one of a video wall, a desktop computer, a notebook computer, a car computer, a personal digital assistant, a tablet computer, a smart phone, and a wearable device and to control at least one of the at least one detection module and the at least one control module.

18. The intelligent monitoring automatic control system of the airtight poultry house according to claim 8, wherein the database comprises a human-machine interface to allow at least one user to register, log in, and manage the plurality of analytical data via at least one of a video wall, a desktop computer, a notebook computer, a car computer, a personal digital assistant, a tablet computer, a smart phone, and a wearable device and to control at least one of the at least one detection module and the at least one control module.

19. An airtight poultry house, comprising:
an airtight poultry house body comprising at least one poultry farming area; and
An intelligent monitoring automatic control system disposed in the poultry house body to control an airtight state of the at least one poultry farming area in the poultry house body, comprising: at least one detection module, disposed in a processing unit, configured for generating a farming area data according to an airtight state of at least one poultry farming area; at least one control module, disposed in the processing unit, wherein each of the at least one control module is provided with a processing unit automatic control rule, and each of the at least one control module is configured to automatically control the airtight state of the at least one poultry farming area via the processing unit according to the processing unit automatic control rule and the farming area data, so that the at least one poultry farming area is in a negative pressure state; and a database configured to store the farming area data via the processing unit, and the processing unit automatically generates a plurality of analytical data according to the farming area data and the airtight state of the at least one poultry farming area; wherein each of the plurality of analytical data is to be read by at least one of a video wall, a desktop computer, a notebook computer, a car computer, a personal digital assistant, a tablet computer, a smart phone, a digital photo frame, a wearable device, and an alarm via the processing unit.

20. The airtight poultry house according to claim 19, wherein the poultry house body has a fan at one end in a length direction and side windows at two sides in a span direction.
